(19) United States
(12) Patent Application Publication
(10) Pub. No.: US 2016/0062748 A1
(43) Pub. Date: Mar. 3, 2016

(54) EMBEDDED DOMAIN SPECIFIC LANGUAGES AS FIRST CLASS CODE ARTIFACTS

(71) Applicant: GOOGLE INC., Mountain View, CA (US)

(72) Inventors: Jeffrey van GOGH, Mountain View, CA (US); Fuyao ZHAO, Mountain View, CA (US); Michael Joseph FROMBERGER, Mountain View, CA (US)

(21) Appl. No.: 14/471,777

(22) Filed: Aug. 28, 2014

(51) Int. Cl. G06F 9/45

(52) U.S. Cl. CPC G06F 8/42

(57) ABSTRACT

Provided are methods and systems for expanding semantic information generated for source code to include information about embedded programming languages contained within source code. The methods and systems utilize a semantic model containing information that allows a user to navigate between the EDSL constructs and the constructs in the general purpose language that surround the invocation of the EDSL. These constructs and the relations between them are modeled as a semantics graph comprised of nodes and edges, where the nodes represent a specific kind of source construct and the edges model relations between the nodes. The methods and systems assist users in determining where code from a general purpose language interacts with an embedded language, provide the user with an understanding of how the boundary between these languages is crossed, and make it so that the user can more easily comprehend the code that he or she is looking at.

### BACKGROUND

Developers write large amounts of code in general purpose programming languages (e.g., programming languages that are not limited to use within a specific application domain, but instead may be used for writing software in a variety of application domains) such as, for example, C++, Java, etc. Sometimes these general purpose languages are not expressive enough or are too verbose for a certain domain of problems. One approach developers use to get around these problems or to be more productive is to use domain specific languages (e.g., programming languages designed specifically for a particular application domain).

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

The present disclosure generally relates to methods and systems for providing web services to users. More specifically, aspects of the present disclosure relate to providing users with semantic information about embedded programming languages contained within general purpose programming languages.

One embodiment of the present disclosure relates to a computer-implemented method comprising: analyzing general purpose programming language in a source file using a general purpose programming analyzer, wherein the general purpose programming analyzer includes an extension for analyzing embedded programming languages; in response to the general purpose programming analyzer detecting an embedded programming language in the source file, invoking the extension for analyzing embedded programming languages; providing data about the general purpose programming language to the extension for analyzing embedded programming languages; and generating semantic information about the embedded programming language and the general purpose programming language, wherein the semantic information associates portions of the source file that are in the embedded programming language with portions of the source file that are in the general purpose programming language.

In another embodiment, the method further comprises adding the semantic information about the embedded programming language and the general purpose programming language to a model created for the embedded programming language and the general purpose programming language.

In another embodiment, the method further comprises analyzing an abstract syntax tree of a construct invoking the extension for analyzing embedded programming languages, and providing data about the general purpose programming language to the extension for analyzing embedded programming languages based on the analysis of the abstract syntax tree.

In yet another embodiment, the method further comprises using heuristics to map arguments of the general purpose programming language to other locations in an abstract syntax tree of the general purpose programming language, and providing data about the general purpose programming language to the extension for analyzing embedded programming languages based on the mapped arguments.

In still another embodiment, the method further comprises determining, based on the data about the general purpose programming language provided to the extension for analyzing embedded programming languages, that one of the nodes from the general purpose programming language has a unique name, and addressing the node from the general purpose programming language using the unique name.

In yet another embodiment, the method further comprises adding to the graph, by the general purpose programming analyzer, a node having a non-unique name and a set of edges between the node having the non-unique name and the node having the unique name, and adding, by the extension for analyzing embedded programming languages, an edge to the node having the non-unique name, where the node having the unique name is identified using the edges from the node having the non-unique name.

Another embodiment of the present disclosure relates to a system comprising one or more processors, and a non-transitory computer-readable medium coupled to the one or more processors having instructions stored thereon that, when executed by the one or more processors, cause the one or more processors to perform operations comprising: analyzing general purpose programming language in a source file using a general purpose programming analyzer, wherein the general purpose programming analyzer includes an extension for analyzing embedded programming languages; in response to the general purpose programming analyzer detecting an embedded programming language in the source file, invoking the extension for analyzing embedded programming languages; providing data about the general purpose programming language to the extension for analyzing embedded programming languages; and generating semantic information about the embedded programming language and the general purpose programming language, wherein the semantic information associates portions of the source file that are in the embedded programming language with portions of the source file that are in the general purpose programming language.

In another embodiment, the one or more processors of the system are caused to perform further operations comprising adding the semantic information about the embedded programming language and the general purpose programming language to a model created for the embedded programming language and the general purpose programming language.

In another embodiment, the one or more processors of the system are caused to perform further operations comprising analyzing an abstract syntax tree of a construct invoking the extension for analyzing embedded programming languages, and providing data about the general purpose programming language to the extension for analyzing embedded programming languages based on the analysis of the abstract syntax tree.

In yet another embodiment, the one or more processors of the system are caused to perform further operations comprising: using heuristics to map arguments of the general purpose programming language to other locations in an abstract syntax tree of the general purpose programming language; and providing data about the general purpose programming language to the extension for analyzing embedded programming languages based on the mapped arguments.

In still another embodiment, the one or more processors of the system are caused to perform further operations comprising: performing control-flow analysis for the general purpose programming language; and providing data about the general purpose programming language to the extension for analyzing embedded programming languages based on the control-flow analysis.

In another embodiment, the one or more processors of the system are caused to perform further operations comprising: performing dynamic program analysis for the general purpose programming language; and providing data about the general purpose programming language to the extension for analyzing embedded programming languages based on the dynamic program analysis.

In yet another embodiment, the one or more processors of the system are caused to perform further operations comprising: using machine learning to determine relations between the general purpose programming language and the embedded programming language; and providing data about the general purpose programming language to the extension for analyzing embedded programming languages based on the relations determined from the machine learning.

In still another embodiment, the one or more processors of the system are caused to perform further operations comprising: determining, based on the data about the general purpose programming language provided to the extension for analyzing embedded programming languages, that one of the nodes from the general purpose programming language has a unique name; and addressing the node from the general purpose programming language using the unique name.

In still another embodiment, the one or more processors of the system are caused to perform further operations comprising: adding to the graph, by the general purpose programming analyzer, a node having a non-unique name and a set of edges between the node having the non-unique name and the node having the unique name; and adding, by the extension for analyzing embedded programming languages, an edge to the node having the non-unique name, where the node having the unique name is identified using the edges from the node having the non-unique name.

Yet another embodiment of the present disclosure relates to one or more non-transitory computer readable media storing computer-executable instructions that, when executed by one or more processors, causes the one or more processors to perform operations comprising: analyzing general purpose programming language in a source file using a general purpose programming analyzer, wherein the general purpose programming analyzer includes an extension for analyzing embedded programming languages; in response to the general purpose programming analyzer detecting an embedded programming language in the source file, invoking the extension for analyzing embedded programming languages; providing data about the general purpose programming language to the extension for analyzing embedded programming languages; and generating semantic information about the embedded programming language and the general purpose programming language, wherein the semantic information associates portions of the source file that are in the embedded programming language with portions of the source file that are in the general purpose programming language.

In one or more other embodiments, the methods and systems described herein may optionally include one or more of the following additional features: the semantic information about the embedded programming language and the general purpose programming language is added to the model as nodes and edges in a graph; the data about the general purpose programming language provided to the extension for analyzing embedded programming languages includes information associating a construct of the embedded programming language to constructs from the general purpose programming language that are relevant to the invocation of the extension for analyzing embedded programming languages; the constructs from the general purpose programming language include one or more of: arguments, instances on which the embedded programming language is called, and scope of the instances on which the embedded programming language is called; the data about the general purpose programming language provided to the extension for analyzing embedded programming languages is based on control-flow analysis performed for the general purpose programming language; the data about the general purpose programming language provided to the extension for analyzing embedded programming languages is based on dynamic program analysis performed for the general purpose programming language; the data about the general purpose programming language provided to the extension for analyzing embedded programming languages is based on machine learning used to discover relations between the general purpose programming language and the embedded programming language; and/or the nodes in the graph include nodes from the embedded programming language and nodes from the general purpose programming language, and wherein the edges in the graph cross between the nodes from the embedded programming language and the nodes from the general purpose programming language.

Embodiments of some or all of the processor and memory systems disclosed herein may also be configured to perform some or all of the method embodiments disclosed above. Embodiments of some or all of the methods disclosed above may also be represented as instructions embodied on transitory or non-transitory processor-readable storage media such as optical or magnetic memory or represented as a propagated signal provided to a processor or data processing device via a communication network such as an Internet or telephone connection.

Further scope of applicability of the methods and systems of the present disclosure will become apparent from the Detailed Description given below. However, it should be understood that the Detailed Description and specific examples, while indicating embodiments of the methods and systems, are given by way of illustration only, since various changes and modifications within the spirit and scope of the concepts disclosed herein will become apparent to those skilled in the art from this Detailed Description.

### BRIEF DESCRIPTION OF DRAWINGS

These and other objects, features, and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example system for expanding semantic information generated for source code to include information about embedded programming languages contained within the source code according to one or more embodiments described herein.

FIG. 2 is a block diagram illustrating nodes and edges in an example of an existing semantics graph.

FIG. 3 is a block diagram illustrating example nodes and edges in an expanded semantics graph according to one or more embodiments described herein.

FIG. 4 is a flowchart illustrating an example method for expanding semantic information generated for source code to include information about embedded programming languages contained within the source code according to one or more embodiments described herein.

FIG. 5 is a block diagram illustrating an example computing device arranged for expanding semantic information generated for source code to include information about embedded programming languages contained within the source code according to one or more embodiments described herein.

The headings provided herein are for convenience only and do not necessarily affect the scope or meaning of what is claimed in the present disclosure.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples and embodiments of the methods and systems of the present disclosure will now be described. The following description provides specific details for a thorough understanding and enabling description of these examples. One skilled in the relevant art will understand, however, that one or more embodiments described herein may be practiced without many of these details. Likewise, one skilled in the relevant art will also understand that one or more embodiments of the present disclosure can include other features not described in detail herein. Additionally, some well-known structures or functions may not be shown or described in detail below, so as to avoid unnecessarily obscuring the relevant description.

Under existing approaches, users typically look-up and review large pieces of code in a textual way. Some integrated development environments (or interactive development environments) (IDEs) allow users to navigate through code based on a semantic understanding of the code. However, such an approach does not scale well to all code databases (e.g., large code databases) that some entities maintain. For example, some code databases may be large enough that using an IDE to search the code is impractical (or even unworkable). Without the service described herein, an IDE may be a client of the system/service described herein.

Accordingly, the methods and systems of the present disclosure are designed to make such large code bases understandable in a textual way so that the code bases can be more easily and efficiently navigated. For example, in accordance with one or more embodiments described herein, where a user sees a method being called, the user can jump to the location within the code where the method is defined. Similarly, if the user desires to see all the locations within the code where a particular method is called, such information can be provided to the user without requiring the user to search the entire code base.

As described above, because general purpose programming languages (e.g., C++, Java, etc.) are sometimes not expressive enough, or are too verbose, for certain domain specific problems, developers often use embedded languages within these general programming languages. For example, developers may use Embedded Domain Specific Languages (also known as EDSL) to avoid the potential issues described above with respect to general purpose languages. In the case of EDSL, the domain specific language is accessed as a library from the general purpose programming language (in even more specific cases, the general purpose programming language can also provide special syntax to switch to the embedded language). One example of such an EDSL is Format Strings, in which longer strings are built using special markup and a set of arguments instead of the developer using concatenation to build the longer string. Benefits of using this pattern include readability, performance optimization, improved localizability, and the ability to perform static analysis on the embedded language. Other examples of embedded programming languages include C# LINQ, regular expressions, etc.

However, many existing analyses for obtaining semantic information about large code databases were written for general purpose programming languages, and not for embedded programming languages. As such, the moment a user moves from a general purpose programming language into one of these embedded programming languages, which are often encoded as strings, the analyses stop providing the desired semantic information about the code.

In view of the above issue, the methods and systems described herein are designed to assist a user (e.g., a developer) in determining where code from a general purpose programming language interacts with an embedded programming language, provide the user with an understanding of how the boundary between these languages is crossed, and make it so that the user can more easily comprehend the code that he or she is looking at.

More particularly, embodiments of the present disclosure relate to methods and systems for expanding semantic information generated for source code to include information about embedded programming languages contained within the source code.

IDEs typically include various functionalities (e.g., jump-to-definition, find references, highlighting of related code, etc.) that allow developers to navigate and understand their source code. These functionalities are often implemented by running the compiler of the general purpose programming language in a special mode where the IDE can extract this information from the compiler. As the compiler only knows about the general purpose programming language, the compiler is not able to bridge between the general purpose programming language and any embedded programming language used in the code. For example, in the case of String Formatters, no jump-to-definition, find references, or code highlighting is possible between the formatter marker and the variables from the general purpose programming language.

For example, suppose the following:

String what=“demoing”;

String longString=String.format (“This is a long string for % s for purposes of the present example”, what);

In the above example, a developer could do any of the following: (1) click jump-to-def on the ‘what’ argument to the String.format method call and be taken to the ‘what’ variable declaration; (2) ask for cross-references on the ‘what’ string variable declaration and find the argument to String.format; or (3) hover over one of the usages/declarations of ‘what’ and see the other related places in the code.

However without the methods and systems of the present disclosure, the developer would not be able to see the usage and/or relation of the ‘% s’ inside the format string.

While some existing static analyses such as, for example, cross-site scripting analysis and SQL injection attack analyses, attempt to bridge the gap between domain specific languages and general purpose languages, these existing approaches lack the semantic navigation functionalities of the methods and systems of the present disclosure.

As will be further described herein, the methods and systems of the present disclosure utilize a semantic model containing information that allows a developer to navigate between the EDSL constructs and the constructs in the general purpose language that surround the invocation of the EDSL.

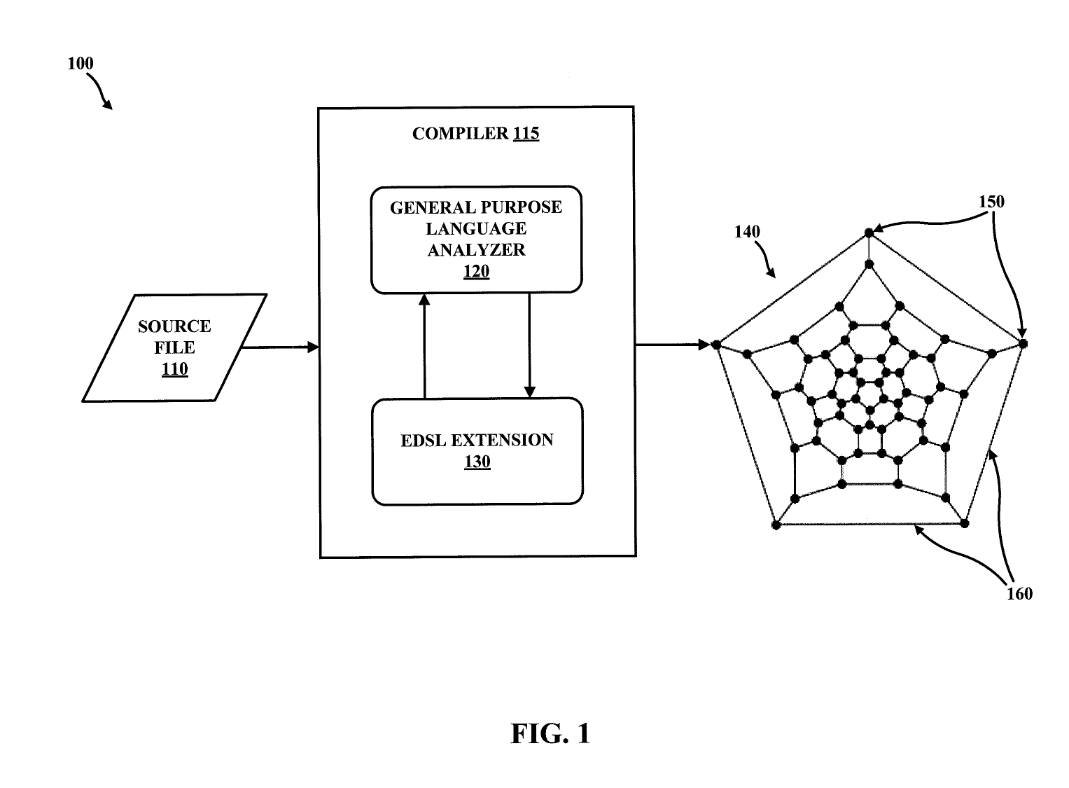

FIG. 1 illustrates an example system 100 for expanding semantic information generated for source code to include information about embedded programming languages contained in the source code. In accordance with at least one embodiment, the EDSL constructs, the constructs in the general purpose language that surround the invocation of the EDSL, and the relations between them may be modeled as a semantics graph 140 comprised of nodes 150 and edges 160. For example, the nodes 150 in the graph 140 may represent a specific kind of source construct (e.g., a type, a method, a variable, a literal, etc.) and the edges 160 may model relations between these nodes 150 (e.g., a piece of code is a method call from one method to another method, a certain class implements a certain interface, etc.).

In accordance with at least one embodiment, the semantics graph 140 may be built by tooling an Analyzer 120, which extracts the semantic information from the source code 110. For example, the Analyzer 120 may be configured to extract the semantic information by running the compiler for the particular programming language involved and extracting the internal details from the compiler to build the parts (e.g., nodes 150 and edges 160) of the graph 140.

In accordance with one or more embodiments of the present disclosure, the graph 140 that may be built (e.g., constructed, generated, etc.) for the source code 110 may be based on information obtained from the compiler 115 (e.g., from the parser, abstract syntax tree (AST), symbol table, etc. (not shown in FIG. 1)). Graph 140 may include nodes 150 and edges 160, where the nodes 150 point to pieces of the source code 110 (e.g., a method code, a method definition, and the like) and the edges 160 denote relations between these pieces of the source code 110. The graph 140 that may be built for the source code 110 is not language specific, but rather can model all of the different general purpose programming languages that may be used in the code 110.

The methods and systems of the present disclosure expand the graph 140 to not just contain information about general purpose programming languages, but also to contain information about various embedded programming languages (e.g., domain specific programming languages) that may exist in the source code 110. For example, the graph 140 may be expanded by adding edges 160 (e.g., relations) between pieces of the code 110 (e.g., nodes 150) that are in an embedded programming language and pieces of the code 110 (e.g., nodes 150) that are in a general purpose programming language. By adding specific nodes 150 for the embedded language pieces of the code 110, and adding edges 160 for the relations between these embedded language pieces and the general purpose language pieces of the code 110, when the compiler 115 operates on the source code 110 these embedded language pieces may be detected and special code may be run to emit the nodes 150 and edges 160 to the graph 140.

Although the creation of nodes 150 and edges 160 for embedded programming languages is described in the context of String Formatters, it should be understood that such nodes and edges may also be created for any of a variety of other embedded programming languages that may be used in the source code 110. For each of these other embedded programming languages, either a very specific kind of node and edges may be created for the purpose of modeling (e.g., in a semantics graph such as graph 140), or a more general or generic combination of node and edges may be created for modeling. The decision to create a very specific kind of node and edges for a given embedded language or instead create a more general kind of node and edges may be based on whether the user wishes to be able to abstract the node and edges for different embedded languages.

In order to get data about the EDSL inside the general purpose language for which the Analyzer 120 is written, an EDSL Extension 130 may be added to the Analyzer 120. In accordance with at least one embodiment, the EDSL Extension 130 can be hard-coded in this tooling, while in accordance with one or more other embodiments, the EDSL Extension 130 can be hard-coded through a plug-in layer or may be run as a separate process or service altogether.

The EDSL Extension 130 acts as an analyzer of the EDSL contained in the source code 110 in that the EDSL Extension 130 understands the semantics of this particular language. The EDSL Extension 130 may emit (e.g., generate, produce, output, provide, etc.) these semantics to the general framework for providing semantic information, using established channels (that may also be used for the General Purpose Language Analyzer 120 the Extension 130 is a part of). Depending on the particular implementation, the semantics data generated by the Extension 130 may be directly surfaced to users, further processed, or stored (e.g., on a disk).

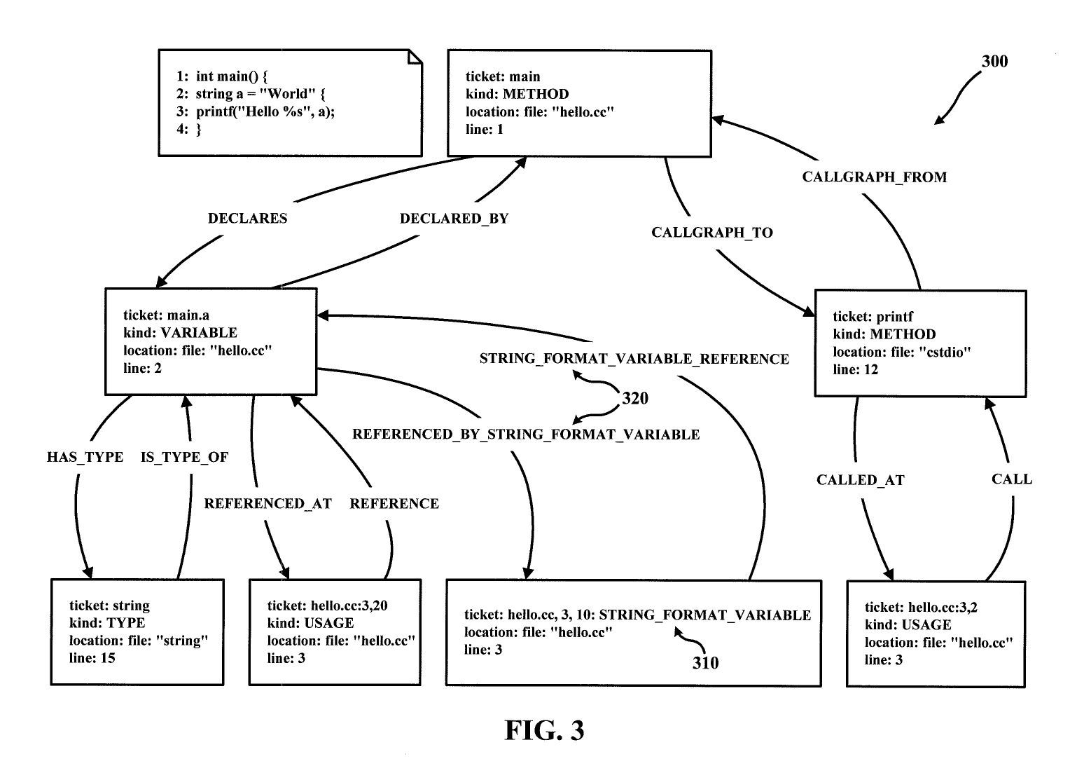

The EDSL Extension 130 may emit the semantic information about the EDSL either tagged with normal kinds (e.g., node kind VARIABLE, edge kind REFERENCE/REFERENCED_BY, etc.) or the Extension 130 could be configured to emit unique kinds such that tooling that retrieves the semantic information can take special actions on these EDSL constructs. Some non-limiting examples of these unique kinds includes node kind STRING_FORMAT_VARIABLE (identified as 310 in the example semantics graph 300 shown in FIG. 3, which is described in greater detail below), edge kind STRING_FORMAT_VARIABLE_REFERENCE/REFERENCED_BY_STRING_FORMAT_VARIABLE (identified as 320 in the example semantics graph 300 shown in FIG. 3), etc.

As described above, the nodes comprising the semantics graph of the present disclosure (e.g., nodes 150 in graph 140 of the example system 100 shown in FIG. 1) may represent places or abstractions in source code, while the edges of the graph (e.g., edges 160 in graph 140 of the example system 100 shown in FIG. 1) may represent the relations between these places/abstractions.

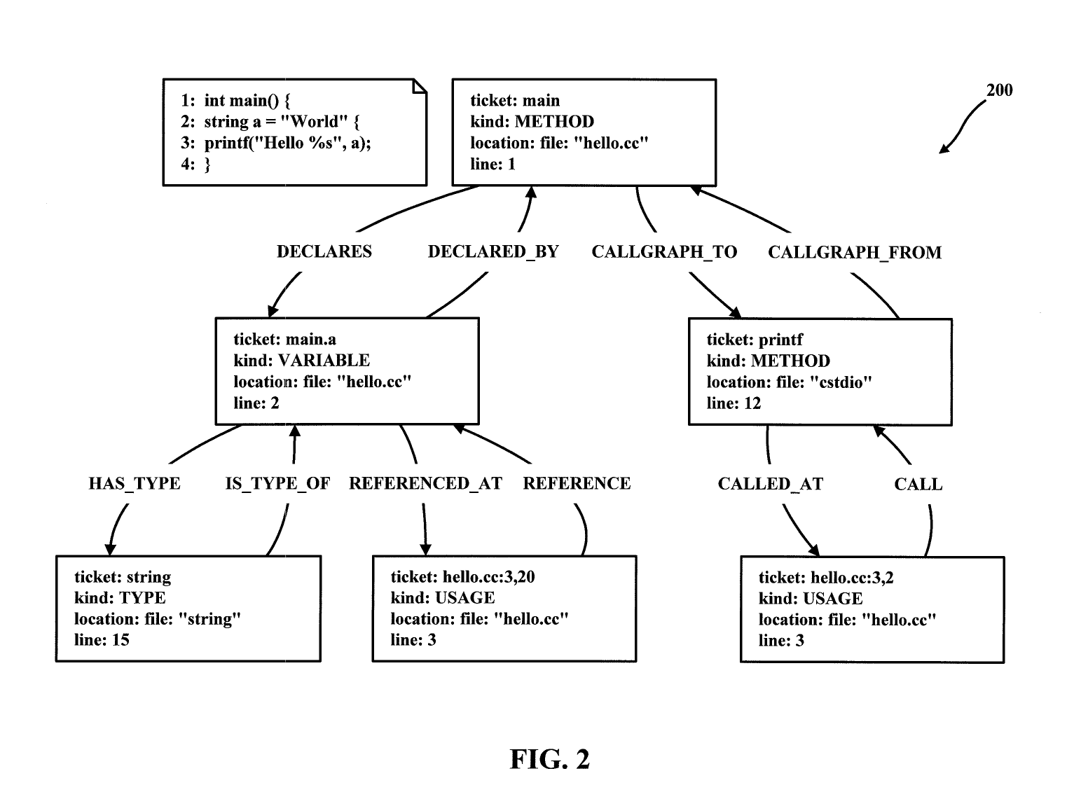

FIG. 2 illustrates an example of an existing semantics graph 200, where all the nodes and edges are related to places in the general purpose programming language.

FIG. 3 illustrates an example semantics graph 300 in accordance with one or more embodiments of the present disclosure. As compared to existing semantics graphs (e.g., graph 200 shown in FIG. 2), example semantics graph 300 includes additional nodes and edges that represent places in the EDSL, as well as additional edges that bridge between the EDSL and the general purpose programming language.

When the General Purpose Language Analyzer 120 invokes the EDSL Extension 130, the General Purpose Language Analyzer 120 may provide the Extension 130 with enough information to tie the EDSL construct back to the constructs from the general purpose language that are relevant to the invocation of the EDSL. Some non-limiting and non-exhaustive examples of such constructs from the general purpose language include the following:

Arguments: literals, expressions, variables;

Instance on which the EDSL method is called; and

Scope the call is made.

The EDSL Extension 130 needs to know about the general purpose language so that the Extension 130 is able to bridge the gap between the general purpose language and the embedded languages, and emit the edges 160 between the nodes 150 in graph 140. The more data that the General Purpose Language Analyzer 120 is able to provide to the Extension 130 about the general purpose language, the better Extension 130 will be able to determine the various relations between pieces of the code 110 (e.g., nodes 150) that are in the general purpose language and pieces of the code 110 (e.g., nodes 150) that are in the embedded language, and emit edges 160 accordingly.

In accordance with one or more embodiments described herein, information about general purpose programming languages may be provided to the EDSL Extension 130 in a number of different ways.

In accordance with one or more embodiments of the present disclosure, the General Purpose Language Analyzer 120 may use any of a variety of strategies or processes to provide data about general purpose programming languages to the EDSL Extension 130. For example, the Analyzer 120 may provide such data to the Extension 130 by: (i) analyzing the Abstract Syntax Tree (AST) of the construct invoking the EDSL; (ii) by using heuristics to map the arguments to other locations in the AST of the general purpose language; (iii) by using control-flow/dataflow analysis (e.g., to determine the order in which individual statements, instructions, function calls, etc. of a program are executed or evaluated); (iv) by using results from earlier dynamic program analysis (e.g., performed by executing programs on a real or virtual processor); and/or (v) by using technologies such as machine learning to discover relations between the two languages.

In accordance with one or more embodiments, the Analyzer 120 may use the data about the general purpose programming language to emit edges that cross between nodes from the EDSL and nodes from the general purpose language (e.g., edges 160 that cross between nodes 150 in graph 140 in the example system 100 shown in FIG. 1).

As the Analyzer 120 is running as an extension, the Analyzer 120 should usually know how to address (e.g., name) the nodes from the general purpose programming language. However, in situations where the Analyzer 120 is unable to gain access to the data structures of the general purpose programming language (e.g., running in a different process, or the API is not exposed in a way that allows this), either of the following example alternatives may be used to address the nodes from the general purpose programming language:

(1) The General Purpose Language Analyzer 120 may be configured to provide enough data to name the node uniquely; or

(2) The EDSL Analyzer may be configured to be less precise in naming the node on the general purpose language side (which still leads to useful data, but possibly with slightly less accuracy). For example, suppose there is a node in the general purpose programming with a unique name, but the extension does not know this unique name. In accordance with one or more embodiments described herein, the general purpose language analyzer (e.g., General Purpose Language Analyzer 120) may emit an additional node with a non-unique name (as they are non-unique, this node can be emitted several times) and a set of edges between the uniquely named node and the non-uniquely named node (e.g., HAS_PARTIAL_NAME/PARTIAL_NAME_OF). The extension may then emit an edge to that non-unique node. The users of the graph can resolve the set of unique named nodes by visiting the edges from the non-unique node.

Once the General Purpose Language Analyzer 120 and the EDSL Extension 130 have completed their operations, the data may be the same as any other part of building the index and the remainder of the tooling may proceed in a typical manner. However, in accordance with at least one embodiment of the present disclosure, where the tooling wants to leverage the availability of information about the bridge between the EDSL and the general purpose language (e.g., the case where the EDSL extension (e.g., EDSL Extension 130 in the example system 100 shown in FIG. 1) emitted specially tagged nodes and edges), there are numerous ways in which the rest of the tooling could benefit. For example, additional processing may be done when building indexing, special indicators may be provided to the users in a user interface, and the like.

It should be noted that one or more embodiments of the present disclosure may include, or be implemented in conjunction with, an application programming interface (API) that allows users to retrieve the data collected by the methods and systems described herein. For example, a web service may provide a user with access (which may be immediate or instantaneous access) to the data collected from the one or more compilers configured to perform the methods described herein. In accordance with one or more other embodiments, a user may utilize a tool (e.g., a web browser) that enables the user to view his or her source code together with links that interact with one or more servers on which the methods and systems described herein may be implemented.

It should also be understood that the data generated as a result of the methods and systems described herein may be provided to the user in a variety of ways. For example, in accordance with at least one embodiment, the data may be presented in a user interface screen accessible to the user, where the data may be highlighted in the user interface screen for easy identification and interpretation by the user. In accordance with one or more other embodiments, the data may be provided to the user by using a command line, by using a text space IDE, or by any of a number of other ways.

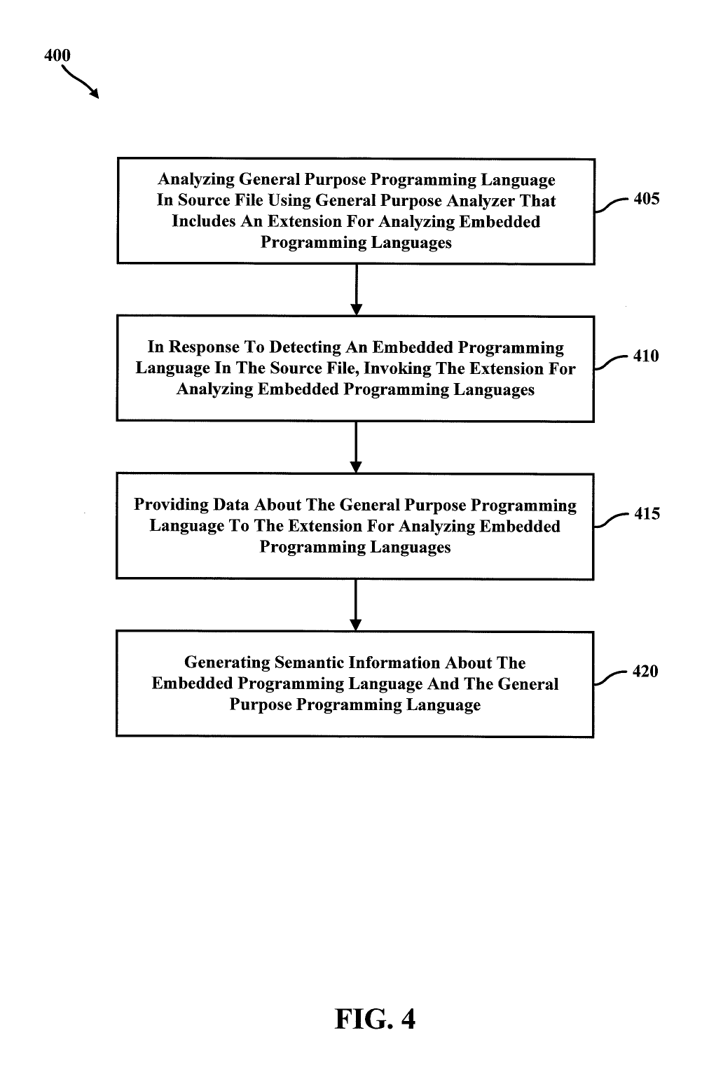

FIG. 4 illustrates an example process for expanding semantic information generated for source code to include information about embedded programming languages contained within the source code. In accordance with one or more embodiments described herein, the example process 400 may be performed by a system similar to system 100 described above and illustrated in FIG. 1.

At block 405, general purpose programming language in a source file may be analyzed using a general purpose programming analyzer (e.g., general purpose programming language in source file 110 may be analyzed using General Purpose Language Analyzer 120 in the example system 100 shown in FIG. 1), where the general purpose programming analyzer includes an extension for analyzing embedded programming languages (e.g., EDSL Extension 130 in the example system 100 shown in FIG. 1).

At block 410, in response to detecting an embedded programming language in the source file, the extension for analyzing embedded programming languages (included with the general purpose programming analyzer) may be invoked.

At block 415, data about the general purpose programming language analyzed at block 405 (e.g., by the general purpose programming analyzer) may be provided to the extension for analyzing embedded programming languages. In accordance with at least one embodiment of the present disclosure, the data about the general purpose programming language that may be provided to the extension for analyzing embedded programming languages (at block 415) may include information associating a construct of the embedded programming language to constructs from the general purpose programming language that are relevant to the invocation (e.g., at block 410) of the extension for analyzing embedded programming languages. The constructs from the general purpose programming language may include, for example, one or more of following: arguments, instances on which the embedded programming language is called, and scope of the instances on which the embedded programming language is called.

In accordance with at least one embodiment, the data about the general purpose programming language may be provided to the extension for analyzing embedded programming languages (at block 415) by the general purpose programming analyzer. Depending on the particular implementation, the general purpose programming analyzer may provide the data about the general purpose programming language to the extension for analyzing embedded programming languages by (i) analyzing an abstract syntax tree of a construct invoking the extension for analyzing embedded programming languages; (ii) using heuristics to map arguments of the general purpose programming language to other locations in an abstract syntax tree of the general purpose programming language; (iii) performing control-flow analysis for the general purpose programming language; (iv) performing dynamic program analysis for the general purpose programming language; or (v) using machine learning to discover relations between the general purpose programming language and the embedded programming language.

At block 420, semantic information about the embedded programming language and the general purpose programming language may be generated, where the semantic information associates portions of the source file that are in the embedded programming language with portions of the source file that are in the general purpose programming language.

In accordance with one or more embodiments of the present disclosure, the example process 400 for expanding semantic information generated for source code may include one or more other operations (not shown) in addition to or instead of the example operations described above with respect to blocks 405-420.

For example, in accordance with at least one embodiment, the semantic information about the embedded programming language and the general purpose programming language (e.g., generated at block 420) may be added to a model created for the embedded programming language and the general purpose programming language. This model may be, for example, a semantics graph (e.g., semantics graph 140 in the example system 100 shown in FIG. 1), and the semantic information about the embedded programming language and the general purpose programming language may be added to the graph as nodes and edges. The nodes added to the graph may include nodes from the embedded programming language and nodes from the general purpose programming language, and the edges added to the graph may cross between the nodes from the embedded programming language and the nodes from the general purpose programming language.

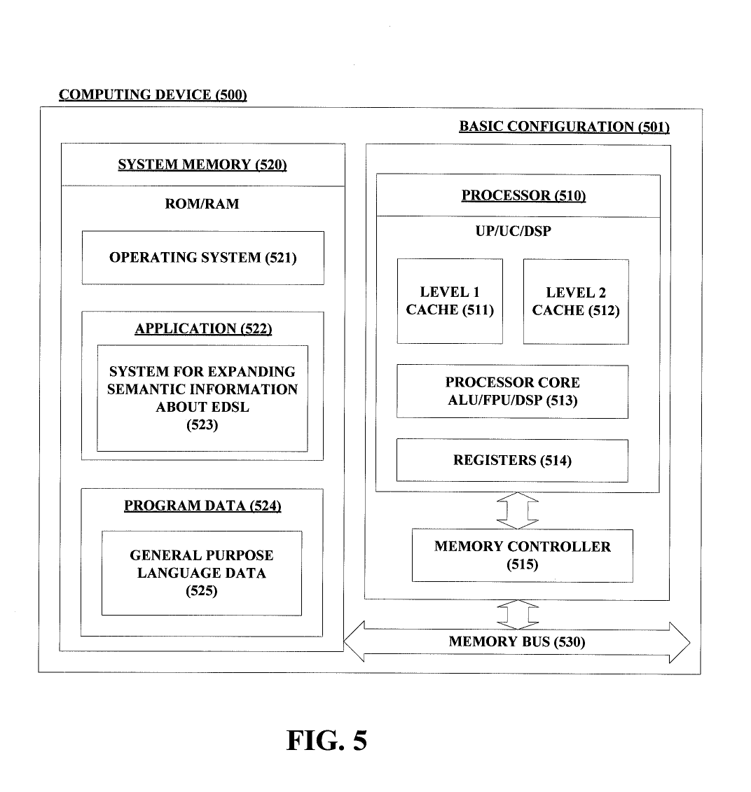

FIG. 5 is a high-level block diagram of an exemplary computer (500) that is arranged for providing expanded semantic information about source code, including information about embedded programming languages contained within the source code, in accordance with one or more embodiments described herein. In a very basic configuration (501), the computing device (500) typically includes one or more processors (510) and system memory (520). A memory bus (530) can be used for communicating between the processor (510) and the system memory (520).

Depending on the desired configuration, the processor (510) can be of any type including but not limited to a microprocessor (μP), a microcontroller (ρC), a digital signal processor (DSP), or any combination thereof. The processor (510) can include one more levels of caching, such as a level one cache (511) and a level two cache (512), a processor core (513), and registers (514). The processor core (513) can include an arithmetic logic unit (ALU), a floating point unit (FPU), a digital signal processing core (DSP Core), or any combination thereof. A memory controller (516) can also be used with the processor (510), or in some implementations the memory controller (515) can be an internal part of the processor (510).

Depending on the desired configuration, the system memory (520) can be of any type including but not limited to volatile memory (such as RAM), non-volatile memory (such as ROM, flash memory, etc.) or any combination thereof. System memory (520) typically includes an operating system (521), one or more applications (522), and program data (524). The application (522) may include a system for expanding semantic information about EDSL (523), which may be configured to assist a user in determining where pieces of source code containing a general purpose programming language interacts with pieces of the code containing an embedded programming language. The system (523) may also be configured to provide the user with an understanding of how the boundary between these languages is crossed, and make it so that the user can more easily comprehend the code that he or she is looking at.

Program Data (524) may include storing instructions that, when executed by the one or more processing devices, implement a system (523) and method for expanding semantic information generated for source code to include information about embedded programming languages contained within the source code. Additionally, in accordance with at least one embodiment, program data (524) may include general purpose programming language data (525), which may relate to data about a general purpose language that an EDSL extension (e.g., EDSL Extension 130 in the example system 100 shown in FIG. 1) may need in order to bridge the gap between the general purpose language and one or more embedded languages contained in source code, and generate semantic information about the interaction between both languages. In accordance with at least some embodiments, the application (522) can be arranged to operate with program data (524) on an operating system (521).

The computing device (500) can have additional features or functionality, and additional interfaces to facilitate communications between the basic configuration (501) and any required devices and interfaces.

System memory (520) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media can be part of the device (500).

The computing device (500) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (500) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In accordance with at least one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It should also be noted that in situations in which the systems and methods described herein may collect personal information about users, or may make use of personal information, the users may be provided with an opportunity to control whether programs or features associated with the systems and/or methods collect user information (e.g., information about a user's preferences). In addition, certain data may be treated in one or more ways before it is stored or used, so that personally identifiable information is removed. For example, a user's identity may be treated so that no personally identifiable information can be determined for the user. Thus, the user may have control over how information is collected about the user and used by a server.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
analyzing general purpose programming language in a source file using a general purpose programming analyzer, wherein the general purpose programming analyzer includes an extension for analyzing embedded programming languages;
in response to the general purpose programming analyzer detecting an embedded programming language in the source file, invoking the extension for analyzing embedded programming languages;
providing data about the general purpose programming language to the extension for analyzing embedded programming languages; and
generating semantic information about the embedded programming language and the general purpose programming language, wherein the semantic information associates portions of the source file that are in the embedded programming language with portions of the source file that are in the general purpose programming language.

2. The method of claim 1, further comprising:
adding the semantic information about the embedded programming language and the general purpose programming language to a model created for the embedded programming language and the general purpose programming language.

3. The method of claim 2, wherein the semantic information about the embedded programming language and the general purpose programming language is added to the model as nodes and edges in a graph.

4. The method of claim 1, wherein the data about the general purpose programming language provided to the extension for analyzing embedded programming languages includes information associating a construct of the embedded programming language to constructs from the general purpose programming language that are relevant to the invocation of the extension for analyzing embedded programming languages.

5. The method of claim 4, wherein the constructs from the general purpose programming language include one or more of: arguments, instances on which the embedded programming language is called, and scope of the instances on which the embedded programming language is called.

6. The method of claim 1, further comprising:
analyzing an abstract syntax tree of a construct invoking the extension for analyzing embedded programming languages; and
providing data about the general purpose programming language to the extension for analyzing embedded programming languages based on the analysis of the abstract syntax tree.

7. The method of claim 1, further comprising:
using heuristics to map arguments of the general purpose programming language to other locations in an abstract syntax tree of the general purpose programming language; and
providing data about the general purpose programming language to the extension for analyzing embedded programming languages based on the mapped arguments.

8. The method of claim 1, wherein the data about the general purpose programming language provided to the extension for analyzing embedded programming languages is based on control-flow analysis performed for the general purpose programming language.

9. The method of claim 1, wherein the data about the general purpose programming language provided to the extension for analyzing embedded programming languages is based on dynamic program analysis performed for the general purpose programming language.

10. The method of claim 1, wherein the data about the general purpose programming language provided to the extension for analyzing embedded programming languages is based on machine learning used to discover relations between the general purpose programming language and the embedded programming language.

11. The method of claim 3, wherein the nodes in the graph include nodes from the embedded programming language and nodes from the general purpose programming language, and wherein the edges in the graph cross between the nodes from the embedded programming language and the nodes from the general purpose programming language.

12. The method of claim 11, further comprising:
determining, based on the data about the general purpose programming language provided to the extension for analyzing embedded programming languages, that one of the nodes from the general purpose programming language has a unique name; and
addressing the node from the general purpose programming language using the unique name.

13. The method of claim 12, further comprising:
adding to the graph, by the general purpose programming analyzer, a node having a non-unique name and a set of edges between the node having the non-unique name and the node having the unique name; and
adding, by the extension for analyzing embedded programming languages, an edge to the node having the non-unique name,
wherein the node having the unique name is identified using the edges from the node having the non-unique name.

14. A system comprising:
one or more processors; and
a non-transitory computer-readable medium coupled to said one or more processors having instructions stored thereon that, when executed by said one or more processors, cause said one or more processors to perform operations comprising:
analyzing general purpose programming language in a source file using a general purpose programming analyzer, wherein the general purpose programming analyzer includes an extension for analyzing embedded programming languages;
in response to the general purpose programming analyzer detecting an embedded programming language in the source file, invoking the extension for analyzing embedded programming languages;
providing data about the general purpose programming language to the extension for analyzing embedded programming languages; and
generating semantic information about the embedded programming language and the general purpose programming language, wherein the semantic information associates portions of the source file that are in the embedded programming language with portions of the source file that are in the general purpose programming language.

15. The system of claim 14, wherein the one or more processors are caused to perform further operations comprising:
adding the semantic information about the embedded programming language and the general purpose programming language to a model created for the embedded programming language and the general purpose programming language.

16. The system of claim 15, wherein the semantic information about the embedded programming language and the general purpose programming language is added to the model as nodes and edges in a graph.

17. The system of claim 14, wherein the data about the general purpose programming language provided to the extension for analyzing embedded programming languages includes information associating a construct of the embedded programming language to constructs from the general purpose programming language that are relevant to the invocation of the extension for analyzing embedded programming languages.

18. The system of claim 17, wherein the constructs from the general purpose programming language include one or more of: arguments, instances on which the embedded programming language is called, and scope of the instances on which the embedded programming language is called.

19. The system of claim 14, wherein the one or more processors are caused to perform further operations comprising:
analyzing an abstract syntax tree of a construct invoking the extension for analyzing embedded programming languages; and
providing data about the general purpose programming language to the extension for analyzing embedded programming languages based on the analysis of the abstract syntax tree.

20. The system of claim 14, wherein the one or more processors are caused to perform further operations comprising:
using heuristics to map arguments of the general purpose programming language to other locations in an abstract syntax tree of the general purpose programming language; and
providing data about the general purpose programming language to the extension for analyzing embedded programming languages based on the mapped arguments.

21. The system of claim 14, wherein the one or more processors are caused to perform further operations comprising:
performing control-flow analysis for the general purpose programming language; and
providing data about the general purpose programming language to the extension for analyzing embedded programming languages based on the control-flow analysis.

22. The system of claim 14, wherein the one or more processors are caused to perform further operations comprising:
performing dynamic program analysis for the general purpose programming language; and
providing data about the general purpose programming language to the extension for analyzing embedded programming languages based on the dynamic program analysis.

23. The system of claim 14, wherein the one or more processors are caused to perform further operations comprising:
using machine learning to determine relations between the general purpose programming language and the embedded programming language; and
providing data about the general purpose programming language to the extension for analyzing embedded programming languages based on the relations determined from the machine learning.

24. The system of claim 16, wherein the nodes in the graph include nodes from the embedded programming language and nodes from the general purpose programming language, and wherein the edges in the graph cross between the nodes from the embedded programming language and the nodes from the general purpose programming language.

25. The system of claim 24, wherein the one or more processors are caused to perform further operations comprising:
determining, based on the data about the general purpose programming language provided to the extension for analyzing embedded programming languages, that one of the nodes from the general purpose programming language has a unique name; and
addressing the node from the general purpose programming language using the unique name.

26. The system of claim 25, wherein the one or more processors are caused to perform further operations comprising:
adding to the graph, by the general purpose programming analyzer, a node having a non-unique name and a set of edges between the node having the non-unique name and the node having the unique name; and
adding, by the extension for analyzing embedded programming languages, an edge to the node having the non-unique name,
wherein the node having the unique name is identified using the edges from the node having the non-unique name.

27. One or more non-transitory computer readable media storing computer-executable instructions that, when executed by one or more processors, causes the one or more processors to perform operations comprising:
analyzing general purpose programming language in a source file using a general purpose programming analyzer, wherein the general purpose programming analyzer includes an extension for analyzing embedded programming languages;
in response to the general purpose programming analyzer detecting an embedded programming language in the source file, invoking the extension for analyzing embedded programming languages;
providing data about the general purpose programming language to the extension for analyzing embedded programming languages; and
generating semantic information about the embedded programming language and the general purpose programming language, wherein the semantic information associates portions of the source file that are in the embedded programming language with portions of the source file that are in the general purpose programming language.
